(19) United States
(12) Patent Application Publication
(10) Pub. No.: US 2007/0196609 A1
(43) Pub. Date: Aug. 23, 2007

(54) Window sheet with pressure sensitive adhesive

(76) Inventor: Mark R. Collins, Summerland, CA (US)

Correspondence Address: WESLEY B. AMES, 7031 LOS VIENTOS SERENOS, ESCONDIDO, CA, 92029, US

(21) Appl. No.: 11/405,829

(22) Filed: Apr. 17, 2006

Related U.S. Application Data
(60) Provisional application No. 60/775,901, filed on Feb. 22, 2006.

(51) Int. Cl. B32B 33/00; B32B 23/02

(52) U.S. Cl. 428/40.1; 428/194

(57) ABSTRACT

Repositionable, adhesive coated sheets are described that have a transparent central portion, such as a window. The sheets can be used for retaining objects on a surface while leaving the objects visible.

### RELATED APPLICATIONS

This application claims the benefit of U.S. Provisional appl. 60/775,901, filed Feb. 22, 2006, which is incorporated herein by reference in its entirety, including drawings.

### FIELD OF THE INVENTION

The present invention relates to repositionable, adhesive-coated sheet materials.

### BACKGROUND OF THE INVENTION

The following discussion is provided solely to assist the understanding of the reader, and does not constitute an admission that any of the information discussed or references cited constitute prior art to the present invention.

Paper sheets that have a pressure sensitive, repositionable adhesive along one edge have been available for more than 30 years. Particularly familiar versions of such sheets are known by the name, POST-IT®. Such sheets are commonly sold in pad form, with a large number of sheets connected using the repositionable adhesive between successive sheets.

A variety of different adhesives and application methods have been described for such repositionable sheets. For example, Silver, U.S. Pat. No. 3,691,140, entitled Acrylate Copolymer Microspheres describes “inherently tacky, elastomeric copolymer microspheres” and indicates that the microspheres can be suspended in a solvent and sprayed to “provide a pressure-sensitive adhesive which has a low degree of adhesion permitting separation, repositioning and re-bonding of adhered objects.”

Merrill et al., U.S. Pat. No. 3,857,731 describes the use of the microspheres as described in U.S. Pat. No. 3,691,140 together with a binder material that partially embeds the microspheres.

Fry, U.S. Pat. No. 5,194,299 describes a repositionable pressure-sensitive adhesive sheet material in which the adhesive is sprayed onto the sheet “resulting in a non-repetitive pattern of adhesive islands.”

As an example of the use of release liners for use with pressure sensitive adhesives, Hennen, U.S. Pat. No. 6,982,107 describes a release liner for pressure sensitive adhesives, where “the release liner includes a film of a thermoplastic elastomeric olefin.”

In another field, bonding of transparent films onto a substrate has been used for forming envelopes that include transparent film covered windows, and techniques for performing such bonding have been described.

One exemplary transparent film material is Melinex 1311, one distributor of which is Plastic Suppliers, 1174 Hayes Industrial Drive, Marrietta, Ga. 35062. Melinex 1311 is a clear film with anti-static properties on both surfaces of its web. Its surface resistivity is said to overcome the static electricity and laser corona-based problems which commonly prevent stacks of plastic films from being used with laser printers. In addition, Melinex 1311 film is indicated to not suffer from unacceptable shrinkage, when passed through the high heat of the fusing stage of a laser printer. Melinex 1311 polyester film is described in more detail in U.S. Pat. No. 4,371,489, which is incorporated herein by reference in its entirety.

Transparent window films have been applied in a number of different ways, including, for example, application of a direct acting adhesive, solvent welding, activation of thermoplastic adhesive, and thermal welding.

### SUMMARY OF THE INVENTION

In many situations, it is helpful to be able to attach small objects to a surface while still being able to remove and/or reposition both the object and the holder. The present invention addresses this problem using removable, adhesive-coated sheets that can be placed over such small objects.

Thus, in a first aspect the invention provides a flexible, adhesive-coated sheet that is peripherally-coated on at least one side (i.e., 1, 2, 3, or 4 sides or full face) of one face with a pressure sensitive, repositionable adhesive; in certain embodiments a central portion of the sheet is not coated with adhesive; the central portion includes a transparent film; the central portion of the sheet includes a two-layer pocket, which may be adhesive-coated on the side corresponding to the peripheral coating.

In advantageous embodiments and uses, placement of the sheet on a surface creates an open-sided pocket or enclosure such that a small object can be held in the pocket or enclosure, that is, a pocket or enclosure between the sheet and a surface to which the sheet is adhered.

In certain embodiments, the sheet material includes a paper perimeter portion and a transparent film central portion; the sheet materials includes a fibrous sheet peripheral portion and a transparent film central portion; the sheet material is a transparent film, which may have a peripheral portion of the face of the sheet opposite the adhesive-coated face textured, coated, or chemically modified such that manual writing and/or machine printing is facilitated; the sheet material is a transparent film except that a fibrous sheet material forms one, two, three, or four peripheral portions; the sheet material includes a fibrous sheet peripheral portion and a transparent film central portion and the transparent film central portion is treated or coated such that manual writing and/or machine printing is facilitated on the transparent film; the sheet material is a transparent film and a fibrous sheet material is adhered to a peripheral portion (e.g., along 1, 2, 3, or 4 sides) on the face opposite the adhesive-coated face; the central portion is expanded (e.g., molded with a surface curve such that a cavity is created) or expandable (e.g., formed with pleats or folds, or stretchable); the central portion is perforated; the central portion is permeable to water vapor but impermeable to liquid water; a perimeter portion and/or a central portion is embossed.

In various embodiments, the present adhesive-coated sheets may be presented in several different formats, including for example, in separate sheets; in the form of a pad in which successive sheets each adhere to the next lower sheet using the adhesive coated on a face of the sheet; in the form of a pad that is glued along one edge, in the form of a pad that is bonded along one side (e.g., glued, staples, or the like) and has a tear line proximate to the bonded side (e.g., a perforated or partially cut line); as separate sheets that have a release liner on the adhesive side; as multiple sheets on a single release liner; as sheets that have a plurality of separate windows in a single sheet, where the separate windows may be separated by adhesive coated portions (but are not necessarily so separated); as a greeting card or mailer combination in which the adhesive coated sheet is provided along with a separate card or mailer substrate sheet, e.g., adhered to a face of the card or mailer substrate sheet.

In particular embodiments, the sheet or sheets in a pad of sheets, have square, rectangular, circular, oval, or irregular shape, or have an outline corresponding to an identifiable object.

In certain embodiments, the sheet includes a peripheral lift area that is not adhesive coated; the peripheral lift area is a corner, a portion of a curve, or a projecting tab (such tab may have a tear line at the junction with the body of the sheet, such as a reduced cross-sectional area, crease, partial cut, or perforation line).

In some embodiments, the sheet is machine printable, e.g., printable with an ink-jet printer, a laser printer, an impact printer, or the like; the printable sheet is on a release liner.

A related aspect provides a method for retaining an object on a surface, where the method involves covering the object with a flexible, windowed sheet that has a pressure sensitive, repositionable adhesive coating on at least three sides of one face (i.e. 3 or 4 sides) such that a central portion of the sheet is not coated with the adhesive, and sealing the pressure sensitive adhesive coating on the surface. Alternatively, the method can involve placing the object in a pocket of a sheet that has a pressure sensitive, repositionable adhesive coating on at least one side (i.e., 1, 2, 3, or 4 sides) of the sheet and adhering the sheet to the surface.

Typically, the sheet is an adhesive-coated sheet as described in the aspect above or otherwise described herein.

In particular embodiments, the covered object is a paper item; a stamp; a photograph; a parking ticket; a scientific data printout; a coin; an electronic component, an article of forensic evidence; a plant part; a geologic specimen; a medicament in solid dosage form (usually a single-dose form), e.g., a capsule or pill.

In another related aspect, the invention provides an adhesive-coated sheet, where the sheet is a flexible, transparent sheet coated on at least a portion of one face (e.g., at least one side) with a removable adhesive, preferably a repositionable adhesive, which will usually be a pressure sensitive adhesive.

The sheet may be coated on one, two, three, four (or all) peripheral portions or sides of a face, or may be fully coated on a face. If a face is fully coated, the adhesive is preferably substantially transparent, that is, sufficiently transparent for a person with normal vision to clearly see an object in contact with the adhesive coated portion of the sheet through the sheet under normal daylight lighting conditions.

In particular embodiments, the sheet is manually writable on the non-adhesive-coated face; the sheet is machine printable on the non-adhesive coated face, e.g., with a laser printer, inkjet printer, impact printer.

A particular related aspect concerns greeting cards or mailers that include an adhesive coated sheet as described above, along with a separate card or mailer substrate. The adhesive coated sheet may be loose (e.g., with release liner covering the adhesive coated portion and inserted in a folded card), adhered at one edge (e.g., using a non-releasable adhesive or chemical or thermal welding), or adhered using a releasable, pressure-sensitive adhesive coating.

In another related aspect, the invention provides a kit that includes a plurality (e.g., at least 10, 20, 50, or 100) of the adhesive coated sheets as described herein for the invention together with instructions for using the sheets, e.g., for using the sheets for at least one particular purpose.

In particular embodiments, the kit includes a plurality of greeting cards or mailers as described herein.

In yet another related aspect, the invention provides a method for retaining an object on a surface by covering the object with a flexible, windowed sheet that has a pressure sensitive adhesive coating on at least three sides of one face, where a central portion of the sheet is not coated with the adhesive, and sealing the pressure sensitive adhesive coating on the surface.

In particular embodiments, the sheet is an adhesive-coated sheet as described in another aspect or otherwise described herein.

In particular embodiments of the above aspects, the adhesive coated sheet is pre-printed, e.g., with a label, such as a label printed with the term “Sample”, “Part No.”, “Price”, the name of a business or individual, grid or scale lines, “Rx”, information concerning a medicine (e.g., name, dosing instructions; warnings, and the like) and/or with lines for manual writing, and the like.

Thus, another aspect concerns a promotion method that involves providing a plurality of adhesive coated sheets as described herein which are printed with a promotional message, e.g., a name, trademark, and/or logo of a company or other organization or product.

Additional embodiments will be apparent from the Detailed Description and from the claims.

### BRIEF DESCRIPTION OF THE DRAWINGS

FIG. 1 shows a sheet with a paper perimeter and a transparent central portion, where the paper perimeter is coated on a portion of one face with a pressure sensitive, repositionable adhesive. The sheet is adhered to a surface and is retaining a coin under the window portion.

FIG. 2 shows a pad of sheets as illustrated in FIG. 1.

FIG. 3 schematically illustrates the adhesive coated side of a sheet such as that shown in FIG. 1.

FIG. 4 schematically illustrates a cross-sectional view of a sheet with a paper perimeter and a transparent central portion where the central portion includes pleats or folds that allow expansion of the central portion, and the sheet is coated on a portion of one face with a pressure sensitive, repositionable adhesive.

FIG. 5 shows a sheet with a paper perimeter and a transparent central portion where 3 sides of the paper perimeter are coated on one face with a pressure sensitive, repositionable adhesive. The sheet is adhered to a surface and is holding a small card such as a business card or ticket.

FIG. 6 shows a sheet with a window portion placed off-center such that a large writing surface is available on one side.

FIG. 7 shows a pad of sheets as illustrated in FIG. 6.

FIG. 8 shows a pad of sheets with a pre-printed line for prescription information.

FIG. 9 shows a sheet as illustrated in FIG. 8 adhered to a water glass and holding pills in place.

FIG. 10 shows a page of horizontally-oriented rectangular sheets with perforated tear lines between the individual sheets.

FIG. 11 shows a sheet in the form of a greeting card and having a round window.

### DETAILED DESCRIPTION OF THE PREFERRED EMBODIMENTS

In many cases, it is desirable for a person to be able to affix an article on a surface, but to still be able to readily remove and/or reposition the article. It is further advantageous to be able to accomplish this without damage to the article or to the surface. One way of fastening articles to surfaces in the past has been to insert the article into a plastic or paper bag or pouch and then to fasten the bag or pouch to the surface, e.g., by stapling, taping, or gluing. A problem with such methods is that the fastening method or removal of the pouch damages many types of substrate materials. For example, stapling produces holes (which may be further torn upon removal), and is not suitable for many surfaces due to limitations on surface material thickness or hardness. Gluing often leaves undesirable residue and/or tears or stretches the surface material and/or the pouch when removed. Many tapes have similar properties to glue, leaving adhesive residue and/or damaging the pouch and/or surface when removed.

The present invention resolves such difficulties and opens up a number of new applications by providing flexible sheets that have a releasable adhesive on at least a portion of one face. Advantageously this adhesive is not only releasable, but also repositionable, that is, it retains sufficient tackiness after removal that the sheet can be adhered one or more additional times (e.g., at least 1, 2, 3, 4, 5 or more additional times) on the same or different surface without treatment or re-application of the adhesive. At the same time, the sheets are constructed such that the central portion of the sheet is transparent such that the article (or the surface under the sheet) can be readily seen.

Thus, typically the invention provides repositionable Post-It®-type note sheets of a variety of different shapes and/or dimensions with clear window portions and “permanently temporary” adhesive on some or all of the borders to entrap or retain objects on a surface or in a pouch, to protect surfaces, or to provide a marking area over a surface, such as a printed, or photographic matter surface.

In many cases, the sheet includes a printable or writable border area, which may be of essentially any desired color. The window material can be selected to have any of a variety of desirable properties, such as optical clarity, UV barrier properties, stretchability, elasticity, and water vapor permeability, among others. The border material may be selected as appropriate for a variety of different applications, such as paper, non-cellulosic fibrous sheet materials (e.g., polypropylene or poly-olefin fiber sheets, such as TYVEK® materials).

As explained below, the sheets may be provided in many different formats, generally including, for example, single sheets, pads, and multi-sheet pages (e.g., mounted on release liner, such as for convenient printing). Various options for the present sheets are discussed in greater detail below.

Physical Forms

The present adhesive coated sheets can be prepared in a large number of different formats and configurations.

One feature that can be varied is the selection of the peripheral portion of the sheet. A common configuration has a paper peripheral portion, with a substantially transparent plastic film central window portion. This configuration has the advantage that the paper portion provides a convenient surface for writing or printing. Such writing or printing can be used, for example, to identify contents of a pouch created by the sheet(s), to record comments or other notes, or to provide further information about the contents. The paper peripheral portion can be along 1, 2, 3, or all 4 sides.

Depending on the application and the requirements or preferences of the user, a large number of different papers and/or paper colors can be used. For example, the paper can be white, yellow, green, pink, or other colors.

In some applications, it may be desirable to replace the paper portion with a different material, such as a fibrous plastic, e.g., TYVEK® (DuPont). Such materials have the advantage that they can be essentially waterproof. This allows such sheets to be used in environments and uses where the sheet may become wet, e.g., from rain. Particular examples of such uses include field sample collection, and placement of parking tickets or other printed material (e.g., advertising materials) on motor vehicle windows.

In configurations that feature a peripheral fibrous sheet portion and a central transparent film portion, the absolute and relative sizes of each portion can be selected consistent with the intended use or common uses.

In some applications, it may be desirable to provide an all plastic sheet. While such sheets can be formed by fusing or otherwise adhering separate pieces for the peripheral portion and the central portion, in many cases it will be preferred to use a single composition for the entire sheet. The sheet may be uniform overall, e.g., smooth or finely textured, or have areas on a face or both faces that are modified. Thus, for example, the sheet may have one or more textured edges (i.e., textured face portion adjacent or proximal to one or more edges). Such textured areas can be advantageous for accepting and retaining markings (e.g., writing or printing) and/or to make such markings more visible and/or to better retain the adhesive. In general, any transparent plastic can be used that will retain the adhesive sufficiently to adhere to a surface and to further retain the adhesive when the sheet is removed from the surface.

In many cases, the entire sheet is provided flat, with no particular provision for expansion, e.g., to assist in holding relatively thick objects. In some cases, however, it is beneficial to accommodate such relatively thick objects. One way of accomplishing this is to use a stretchable film, preferably stretchable in both directions in the plane of the sheet, in the central portion of the sheet. For example, a transparent central portion can be stretchable. The force needed to stretch the film should be matched with the adhesive strength, the strength of any non-stretchable materials in the sheet, and the strength of any bond between any stretchable and non-stretchable portions of the sheet, such that the sheet will remain on the surface without damage. In some cases, the stretchable material is also elastic.

In other embodiments, the central portion is formed to have or allow a cavity. For example, the central portion can be formed of a shape-holding material such that it generally bowl-shaped so that when the sheet is adhered to a surface, a space or gap will be present between the formed portion and the surface. Likewise, the central portion can be formed with pleats, folds, gathers, and the like that provide expansion space. Thus, then the sheet is placed over a relatively thick object, the pleats, etc, allow the central portion to expand or lift providing a gap between that central portion and the surface.

In yet other cases, the central portion will be or include a mesh portion, usually a mesh with sufficiently large opening and thin threads (but still small enough openings to retain desired objects) that an object can be readily seen through the mesh. Such configurations can be useful, for example, in applications in which the object held under the sheet should have continuing good air circulation. Alternatively such ventilation can be provided by using central portions that are perforated or constructed of water vapor permeable material (which can be impermeable to liquid water).

The adhesive on the sheet may be positioned in various ways, e.g., with the location selected as appropriate for the intended application. For example, adhesive can be placed on one peripheral portion (i.e. along one side) of a face similar to current Post-It® note sheets. Such placement is suitable, for example, for sheets that include an integral pouch, e.g., a plastic pouch. The pouch opening can be either on the adhesive coated side or the non-adhesive coated side. Similar pouch-containing sheets may be constructed with adhesive coated on two peripheral portions of a face, e.g., on two non-adjacent sides of the face, e.g., such that the adhesive coated sides extend along the sides of a pouch. Alternatively, the pouch opening may be located on one of the adhesive coated sides, e.g., such that placement of the sheet on a surface effectively closes or seals the pouch. Pouches may be closed in a number of different ways. In addition to remaining open and closure by the sheet adhesive, pouches can for example have snap, flap, or adhesive closures.

In other cases, the adhesive is placed along three sides of a face. While such adhesive placement can be used with sheets that include an integral pouch, in many cases the sheet is single layered, such that a pocket open at one end is formed when the sheet is adhered to a surface. Such a pocket can allow removal (and in some cases reinsertion) of an object without disturbing the placement of the sheet on the substrate surface. In other cases, the sheet is coated around all edges such that an interior, non-coated area will create a cavity when the sheet is placed over an object on a surface.

In other cases, e.g., where it may be desirable to prevent movement of an article within a pocket formed by a sheet on a surface, all or essentially all of a face of the sheet can be coated with adhesive. In such cases, the adhesive in the thickness applied together with the transparent film should be substantially transparent, and/or the adhesive should be applied to restricted areas (e.g., small spots) such that an object held by the sheet can still be readily seen.

The size and shape of the sheets can be selected as appropriate for a variety of applications. In many cases, the sheet will be in the shape of a small rectangle, e.g., 1-4 inches in each direction (e.g., 1-2, 2-3, or 3-4 inches in each direction or any pair of these dimensions).

In other cases, larger rectangles may be beneficial, e.g., 4-12 inches in each direction or even larger in one or both directions. Thus, in particular cases, such sheets may be 4-5, 5-6, 6-7, 7-8, 8-9, 9-10, 10-11, 11-12 inches in each direction, or each pairwise combination of these dimensions, e.g., 4-5 by 6-7 inches.

In some applications rectangular sheets that are substantially larger in one direction than the other are useful. Thus, for example, such sheets may be 6-9 inches in one direction and ½-3 inches in the other (e.g., ½-1, 1-2, or 2-3). As explained below, one application of such sheets is in editing to provide a non-destructive method of entering notes and comments on printed materials (e.g., handwritten, machine printed, and/or pictorial materials).

The present sheets are not limited to rectangular sheets. Instead, any of a variety of non-rectangular shapes can also be used, e.g., shapes as used on paper sheets provided as note pads. For example, such sheets may be round, oval, shaped to have the outline of a recognizable object, or irregular. For such non-rectangular sheets, a side or sides can be defined with reference to the side of the smallest rectangular shape within which the sheet can be included. For specifying the location of adhesive coated on a portion of the non-rectangular sheet, a side of the rectangular sheet is aligned with the axis of the adhesive coating to the extent possible.

As indicated, above, the present sheets can be constructed such that they form a pocket or pouch between the sheet and a surface when the sheet is affixed to the surface. Alternatively, the sheet can be constructed such that it includes a pouch. For example, a plastic pouch can be fastened to a peripheral paper (or other fibrous material) portion, e.g., with the fibrous portion along 1, 2, 3, or 4 sides. In other cases, the peripheral portion is a non-fibrous sheet material, e.g., a plastic. Such non-fibrous peripheral portion may be transparent, translucent, or opaque. The peripheral portion can be mechanically or chemically treated to improve retention of the adhesive and/or to improve the ability of the portion to accept and/or retain writing or printing. The pouch opening can be accessible with the sheet adhered to a surface, or can be inaccessible under such conditions. The sheet may be constructed with a central pouch and peripheral single-layer portions, or may have the pouch extend to one or more edges, e.g., 1, 2, 3, or 4 edges.

In many cases, it will be desirable to provide the sheets in pad form, e.g., similar to POST-IT® note pads. In the case of such note pads, the releasable adhesive is deposited along at least one edge. When stacked in a pad, the adhesive of one sheet adheres to the sheet beneath it, maintaining the integrity of the pad but allowing one sheet at a time to be removed. Similarly, the present sheets can be sequentially adhered, allowing the sheets to be detached one at a time from a pad. Because the adhesive is placed along more than one edge, it may be helpful to leave at least one corner un-coated, thereby allowing a person to grip that corner to pull the sheet away from the pad. In other cases, the pad is constructed using edge gluing or stapling; such formats may have sheets with tear lines for separating individual sheets from the pad. In such pads, the adhesive may be exposed, or may be protected with a release liner, e.g., a release strip.

As an alternative to provision in pad form, the present sheets may be provided on release liner. The sheets may be in the form of single sheets on release liner, or may have multiple sheets on a single release liner (e.g., similar to labels coated with pressure sensitive adhesive) and thus form a multi-sheet page. One of the benefits of sheets supplied on release liner is that a sheet can be machine printed prior to removal of the sheet from the release liner. For example, a sheet with a paper (or other machine printable) peripheral portion can be passed through a printer and desired print placed on the peripheral portion. The sheet components should be selected to be compatible with the intended print method, e.g., able to withstand the temperature experienced during laser printing. Similar to printing on labels supplied on release liners, the sheet dimensions can be standardized such that control software can be provided that controls formatting for printer output, e.g., such that print can be placed on sheet surfaces that are suitable for accepting the print, and not on unsuitable surfaces. For example, the formatting can allow print placement on a peripheral portion and not on a central window portion. The invention also concerns such software and its use in computer-controlled printing.

Thus, in general, the adhesive (as well as any plastic) should be selected to be suitable for the intended application. Besides temperature resistance, selection factors can include one or more of peel strength, color, chemical compatibility, and low temperature and/or high temperature adhesion properties.

An optional feature of the present sheets is the inclusion of measurement lines, scale lines, or grid lines on at least a portion of the sheet. For example, such lines can be placed on a peripheral portion and/or on a central portion. Such lines can, for example, be printed on the surface, included in the internal construction of a sheet portion, or bonded on a surface. Substantially any desired visible scaling can be used, e.g. with lines at 1/32 inch, 1/16 in, ⅛ in, ¼ in, ½ in, 1, 2, 3, 4, 5, 10, or 20 mm.

Construction Methods

In keeping with the factors indicated above as well as others, adhesive should be selected consistent with the intended application. For example, for placement of the sheets on paper surfaces, adhesive should be selected that have sufficient adhesion strength to retain the sheet on the surface, but not so strong that the paper surface is damaged (e.g., by pulling away a substantial fraction of fibers and/or tearing) the paper. In other cases, a stronger adhesive can be utilized. For example, for sheets that are constructed of materials stronger than paper (e.g., TYVEK® or film plastics) and are to be applied to stronger surfaces (e.g., glass, metal, wood, plastic), stronger and/or application-specific adhesives can be used.

For example, as described in Fry, U.S. Pat. No. 5,194,299 (incorporated herein by reference in its entirety), it is advantageous for sheets to be applied to paper surfaces to have peel strengths of about 8-80 grams per centimeter width (g/cm), preferably about 10-50 g/cm. Factors controlling the peel strength are also described therein. However, as indicated above, for other surfaces and/or other sheet materials higher peel strengths can be useful, e.g., 50-500 g/cm, 50-100, 100-200 g/cm, 100-300 g/cm, 300-400 g/cm, 400-500 g/cm, or in some cases even higher peel strengths, e.g., 500-1000 g/cm.

Exemplary adhesives are described in Silver, U.S. Pat. No. 3,691,140 which is incorporated herein by reference in its entirety. Those adhesives are described as containing “inherently tacky, elastomeric copolymer microspheres” which can be suspended in a solvent and sprayed to “provide a pressure-sensitive adhesive which has a low degree of adhesion permitting separation, repositioning and re-bonding of adhered objects.” In a related patent, Merrill et al., U.S. Pat. No. 3,857,731 describes the use of the microspheres as described in U.S. Pat. No. 3,691,140 together with a binder material that partially embeds the microspheres, along with sheet materials coated with such adhesives. Both of those references are incorporated herein by reference in their entireties. As indicated, such adhesives can be applied by various techniques, including rolling and spraying.

In addition to microsphere-containing adhesives such as those described above, removable and/or repositionable adhesives that have higher continuous coat peel strengths (e.g., 100-1000 g/cm) can be used if applied in a manner that decreases peel strength, e.g., by reducing the contact area between the adhesive and the surface to which the coated sheet has been affixed. For example, the use of conventional pressure sensitive adhesives for releasable and/or repositionable sheets is described in Fry, U.S. Pat. No. 5,194,299, which is incorporated herein by reference in its entirety. The '299 patent describes a repositionable pressure-sensitive adhesive sheet material in which the adhesive is sprayed onto the sheet “resulting in a non-repetitive pattern of adhesive islands.” The '299 patent also describes exemplary suitable parameters for such application. As indicated in that reference, other methods can also be used for reducing the adhesive contact area, including for example, applying small areas or spots of adhesive such that adhesive area is reduced, applying narrow strips of adhesive such that adhesive coverage area is reduced (e.g., as described in U.S. Pat. No. 4,743,319 which is incorporated herein by reference in its entirety), using thin coat adhesive, masking portions of the adhesive surface, deactivating portions of the adhesive surface, and the like.

As recognized in the field of adhesive application, it can be advantageous to prime the sheet to be coated, e.g., to obtain better and/or more consistent bonding of an applied adhesive. The primer and associated process are selected to be compatible with the sheet material and the adhesive. For example, such priming is discussed in U.S. Pat. No. 3,857,731 and references cited therein, including U.S. Pat. Nos. 2,328,066; 2,926,105; 2,927,868; and 2,897,960, all of which are incorporated herein by reference in their entireties.

Additional exemplary pressure sensitive adhesives (and in some cases discussion of primer use) is provided in U.S. Pat. Nos. 5,602,214; 4,309,520; 3,992,429; 4,077,993; 5,190,827; 5,175,058; 5,096,981; 3,929,704; and 4,882,377, each of which is incorporated by reference herein in its entirety.

As discussed above, in some applications it can be advantageous to use sheets mounted on release liners. An example of the use of release liners for use with pressure sensitive adhesives is provided in Hennen, U.S. Pat. No. 6,982,107, which is incorporated herein by reference in its entirety. The '107 patent describes a release liner for pressure sensitive adhesives, where “the release liner includes a film of a thermoplastic elastomeric olefin.” As is understood, the selection of release liner will particularly depend on the adhesive used on the sheet.

As described above, in many embodiments, the sheet will have a relatively opaque perimeter portion and a transparent window portion, e.g., a central window portion. In such cases, frequently the perimeter portion and the central portion will be made of different materials, or a least formed of different pieces, that are joined or bonded to form a single sheet. Such bonding can be performed by any of a variety of techniques compatible with the selected materials. For example, methods and materials as used for construction of envelopes that have transparent film windows can be used, e.g., heat bonding, solvent welding, adhesive bonding, heat activated glue bonding. In many cases in which a transparent portion is joined to a perimeter portion, it will be preferred to have the transparent portion joined to the face of the perimeter portion on which the adhesive is coated.

In some cases, texturing or chemical treatment of at least a portion of a sheet will be used, e.g., to improve markability or printability, or to improve the bond between the sheet and adhesive. Physical texturing can be accomplished, for example, using abrasion, hot imprinting, and the like. Chemical treatment, e.g., primer coating, can be used with films to improve surface bonding, e.g., for window material with perimeter material and/or between adhesive and perimeter material and/or window material. Such chemical treatment can chemically modify the surface, provide chemical etching, and/or provide a transitional bonding layer. As understood by those in the field, the chemical treatment is selected to be compatible with the sheet materials and/or adhesive that is used.

Applications

The present adhesive-coated window sheets have a large number of applications, and more are sure to be devised. The various applications can be grouped into at least five categories based on sheet configuration and/or manner of use. First, the sheets can be used to form a “pouch” between the sheet and a generally flat surface to which the sheet is adhered, and an object can be held in that pouch. Second, two sheets can be used to created a separate pouch into which an object can be placed, and which can optionally be separately handled or can be fastened in place or adhered in place by additional adhesive surface(s) on one of the sheets. Third, the sheet may include an actual pouch, such that an object can be placed within the pouch and the pouch fastened to a surface using the adhesive coating. Fourth, the sheet may be placed over another sheet or other work surface bearing printed matter (e.g., text and/or images), for example, to protect the surface and/or to provide a notation surface distinct from the original printed sheet. Fifth, the sheet may be placed over a surface to provide protection to the surface, while leaving a central portion of the surface visible, e.g., protection of CD, DVD, or other recording disks.

In particular applications, the sheets can be used for specimen or sample collection and/or preservation of such specimens or samples.

Such sheets can also be used for packaging of small parts or products, e.g., using two sheets with matching adhesive coated face portions. Such sheets can be printed or otherwise marked with item identification and/or price, among others. For such dual sheet applications, in particular embodiments, the second sheet is a sheet which is not adhesive coated; the two sheets match adhesive coated face portions; matching adhesive coated face portions adhere together more tightly than either adhesive coated face portion will adhere to an un-coated portion of the peripheral portion material.

In another application, the sheets can be used for holding capsules, pills or other such medicament form having a generally solid phase exterior. Such sheets can be shaped with an outline generally in the shape of a capsule or pill. The sheet, e.g., a perimeter portion, can be printed with information about the medicine, e.g., the name of the patient, the name of the medicine, date and/or time for taking the medicine; dosing information, warnings, and the like.

The present sheets can also be used for collection of forensic evidence and/or other field evidence or samples such as any of a variety of natural history specimens.

The sheets may also be used for holding and/or protecting small collectible items, e.g., scrapbook ephemera, coins, paper currency, stamps, photographs, drawings, and the like.

In their protective function, the sheets can be used for archival preservation. In such uses, the materials used are preferably consistent with good archival practice. The sheets can also be used for protection of CDs, DVDs, or other recording disk media.

As used in connection with the present invention, the term “sheet” refers to a planar, flexible item, in which the face dimensions are very large compared to the thickness, e.g., 50-fold or more.

The term “adhesive-coated sheet” refers to a sheet that has an adhesive coating adhering to a face of the sheet. The coating covers a significant fraction of the area of he face, e.g., at least 5, 10, or 20%, or more.

As used in connection with transparent window material, the term “film” means that the material is thin (e.g., less than 1.5 mm in thickness, usually less than 0.5 mm, and in many cases less than 0.3 mm), and essentially homogeneous in the plane of the window (but may have laminated layers). The material may be highly flexible, but may also be somewhat less flexible, e.g., it may be semi-rigid.

The term “flexible” is used herein to indicate that a referenced sheet material or sheet portion can be readily bent substantially in an arc that is initially substantially normal to the plane of the sheet and restored to its original position without apparent damage to the sheet.

The term “peripherally-coated” in connection with adhesive coating on the present sheets means that a coated area is proximal or adjacent to an edge of the sheet, e.g., coated along an edge. The peripheral coating may be along one or more edges of the sheet, e.g., 1, 2, 3, or 4 edges.

The phrase “pressure sensitive, repositionable adhesive” refers to having the property of being able to be readily remove and replace a sheet coated with that adhesive on a surface, such that the sheet will re-adhere to the surface without wetting or other treatment of the adhesive.

As used in connection with the present sheets, the term “perimeter portion” refers to a portion of a sheet that is proximate to an edge of the sheet but not including another portion or portions that are nearer the central area of the sheet. Depending on the context, the term “perimeter portion” may refer to an area on a face of the sheet or to the sheet material itself.

The term “transparent film” refers to a thin flexible sheet through which objects can be clearly seen by a person with normal vision under normal daylight illumination. The film may be slightly colored, or may be clear.

The term “central portion” in reference to a sheet means a portion of the sheet away from any edge.

The phrase “textured such that manual writing is facilitated” means that the face surface of a sheet or portion of a sheet includes or is treated to include irregularities that have the effect of improving the ability of that portion to accept and retain manual writing materials and methods, such as pencil, ball point pen writing, and felt tip pen writing.

The term “release liner” is used conventionally to refer to a sheet to which a selected adhesive has sufficient adhesion so that an adhesive coated sheet will remain adhered to the release liner during normal handling but can be removed without damage to the sheet or to the adhesive coating.

As used herein, the terms “printable” and “machine printable” mean that the referenced material may be normally processed through a machine designed for printing on a sheet material without damage to the machine or to the referenced material, such that the printing will adhere to and persist on the referenced material to a practically acceptable extent. Thus, indication that a material is printable with an inkjet printer, a laser printer, or an impact printer means that the material can be normally processed through such printer without damage and with practically acceptable deposition and retention of printing (e.g., characters, lines, and/or images).

In the context of the present sheets, the term “expandable” means that a portion of the sheet is moveable perpendicular to the plane of the sheet.

The term “pad” is used to refer to a stack of a plurality of sheets with successive sheets fastened together, e.g., with edge gluing or with the adhesive between successive sheets.

The term “pleat” is used herein to refer to a fold in a sheet material that includes at least one crease line (and may include more). It does not mean that there is any stitching or other feature preventing the fold from opening other than the properties of the folded material itself, e.g., degree of stiffness).

The term “stretchable” means that the referenced portion of the sheet will expand in the plane of the sheet face, preferably along both of any two perpendicular directions, at least 10 percent under at most moderate force. In this context, moderate force refers to a force that is less than the force that would tear the sheet, separate a window portion from a peripheral portion, or separate an adhered sheet from a surface for which the sheet has been designed to be used. The stretchable sheet portion may further be elastic.

In connection with the present sheets, the term “waterproof” means that the sheet is not significantly damaged by exposure to liquid water for 30 seconds at room temperature.

Examplary Sheets

In accordance with the description above, many different configurations of the present sheets can be constructed. Examples of some general configurations are shown with reference to the figures.

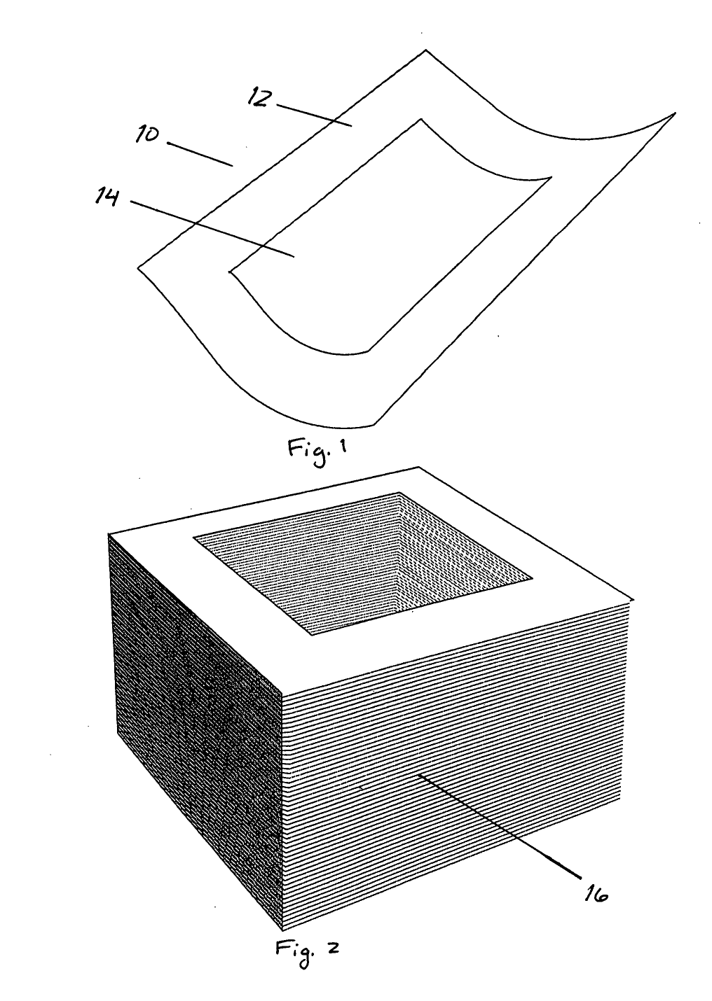

FIG. 1 shows the exposed face of a basic sheet design 10 in which a rectangular paper peripheral portion 12 is bonded with a rectangular, transparent plastic central window portion 16. The peripheral portion is coated on the back side with removable, repositionable pressure sensitive adhesive (not shown). FIG. 2 shows a pad 16 of window sheets as illustrated in FIG. 1, in which the repositionable, pressure-sensitive adhesive on the backs of succeeding sheets removably adheres to the sheet below. In general, the bottom sheet will be adhered to a release liner sheet.

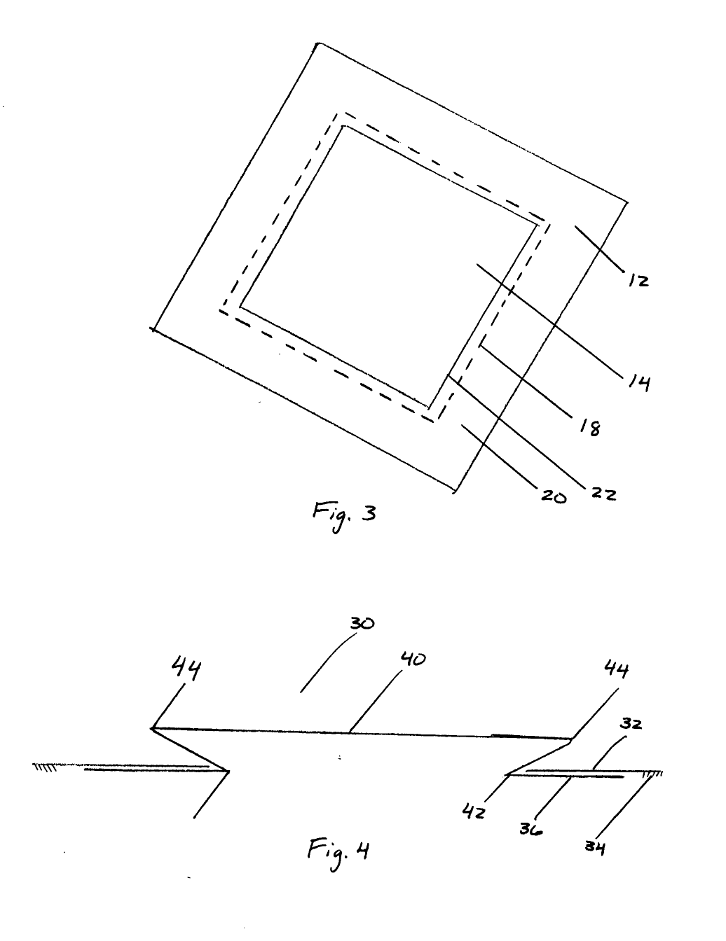

FIG. 3 illustrates the “back” face of a sheet as in FIG. 1. The sheet includes a peripheral portion 12, having adhesive coating area 20. The peripheral portion is bonded with transparent window portion 12. As shown, the edge 14 of the window portion overlaps with the peripheral portion to provide a bonding surface 22.

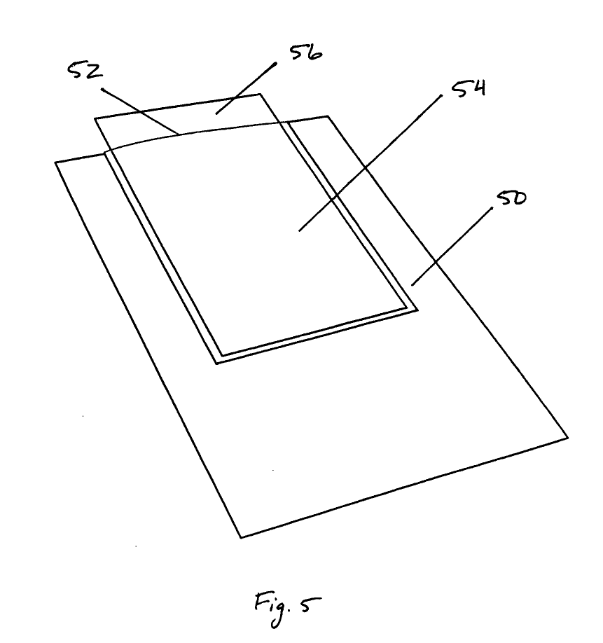

FIG. 4 schematically illustrates a cross-section through a sheet 30 that includes a peripheral portion 32, with adhesive coating 34 on its lower face. Bonded to the lower face at bonding area 36 is transparent window portion 40. The transparent window portion includes lower folds 42 and upper folds 44, creating an expandable pocket which can be advantageous to allow thicker objects to be retained without disturbing the ability of the adhesive coated portions to adhere to a substrate.

FIG. 5 shows another variant in which a peripheral portion 50 is coated on 3 sides of the lower face with adhesive leaving an at least partially uncoated side 52. The sheet includes a central transparent window portion 54 covering and retaining a card 56, such as a business card or ticket. On the uncoated side, the transparent window may form part of the edge, or an opaque or otherwise obscured peripheral portion (e.g., a paper peripheral portion) may form that edge.

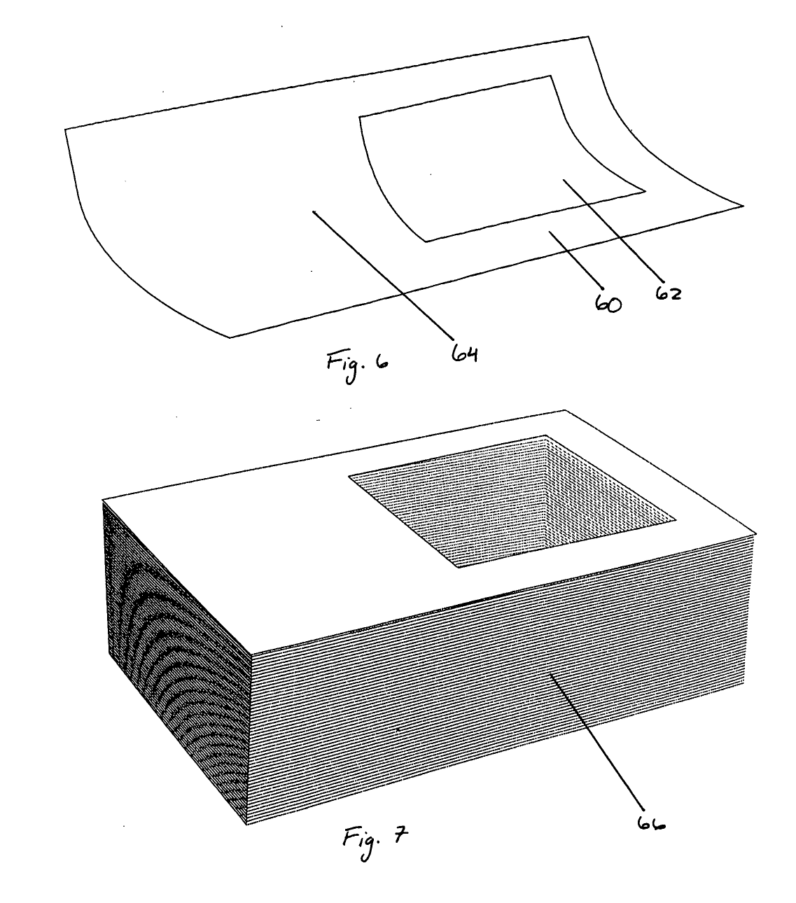

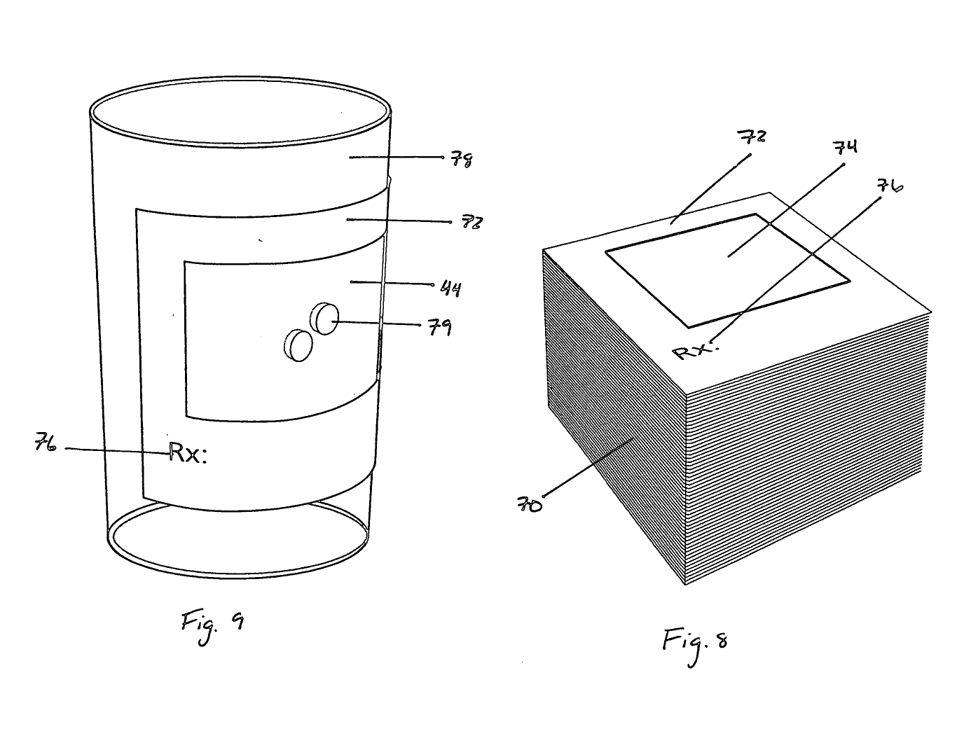

FIG. 6 illustrates another configuration of the present window sheets in which the transparent widow portion is off-center. As before, the sheet includes a peripheral portion 60 coated on one side with a removable, pressure sensitive adhesive, and a transparent window 62. The off-center positioning of the window provides an enlarged writing portion 64. FIG. 7 shows a pad 66 of sheets as illustrated in FIG. 6.

FIG. 8 illustrates a pad 70 of special purpose window sheets. As in other cases, each sheet includes a peripheral portion 72 which has a repositionable, pressure-sensitive adhesive coating on the back, and a transparent window portion 74. In this case the sheets are adapted for retaining medicines and have pre-printed text 76 showing a location for writing prescription information. FIG. 9 shows a sheet as in FIG. 8 adhered to a glass 78 and holding pills 79. Thus, use of such sheets can be advantageous for preparing pills for an individual, e.g., to be available and/or as a reminder for taking pills in the morning or at mealtime.

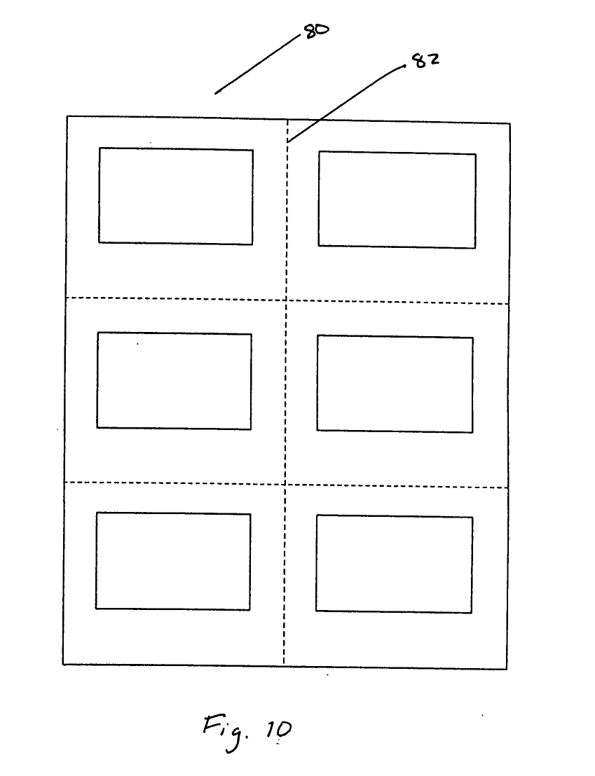

FIG. 10 shows a page 80 of attached window sheets separated with perforated tear lines. As shown, the sheets are rectangles which are longer in the horizontal direction. The size, relative dimensions, and orientation of individual sheets in the page may be selected as desired. In many cases, but not necessarily, the page will be on a release liner such that one or more sheets can be removed when desired. Instead of perforated tear lines between sheets, the separation lines can be continuous cut lines, either partial cut or full cut. In particular, for embodiments in which the page is on a release liner, the separation lines between the individual sheets may be full cut lines. The use of pages of multiple sheets also allows each page to include more than one configuration of sheet, e.g., sheets of different sizes. For example, pages may be arranged with a number of smaller sheets at the top, with one or more larger sizes lower on the page.

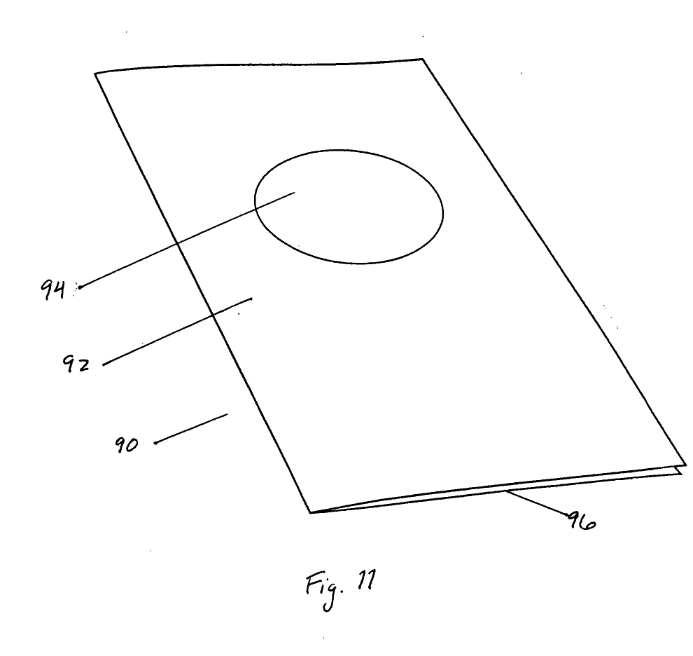

FIG. 11 shows a special purpose window sheet 90, which is configured as a greeting card, with a peripheral portion 92 and a circular transparent window portion 94. The card also has a rear portion 96, which may be continuous with the face sheet (e.g., a folded section of the same sheet) or may be a separate sheet attached to the window sheet. Such greeting cards may be configured in a number of different ways. For example, the window shape and size may be selected as preferred. Further, the card may include a folded substrate sheet, and the window sheet may adhere to the front (exposed) face of the substrate sheet. Alternatively the card may include a flat substrate sheet and the window sheet adheres to a face of the substrate sheet. In yet other alternatives, the substrate sheet includes a window (which may be an opening or may be covered with a transparent window material) and the adhesive coated window sheet adheres to the back or inside of the substrate sheet. In yet other cases, the substrate sheet is coated with the repositionable, pressure-sensitive adhesive and a window sheet lacking adhesive adheres to the front or back (which may be inside) of the substrate sheet. In any of the case, the window allows objects to be placed under the window such that they are visible through the window, enabling an individual to readily personalize the card.

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, variations can be made to the window material, perimeter material, adhesive, and dimensions. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numerical values or value range endpoints are provided for embodiments, additional embodiments are described by taking any 2 different values as the endpoints of a range or by taking two different range endpoints from specified ranges as the endpoints of an additional range. Such ranges are also within the scope of the described invention.

Thus, additional embodiments are within the scope of the invention and within the following claims.

What is claimed is:

1. An adhesive-coated sheet, comprising
a flexible sheet peripherally-coated on at least three sides of a face with a pressure sensitive, repositionable adhesive, wherein a central portion of said sheet is not coated with adhesive.

2. The adhesive coated sheet of claim 1, wherein said flexible sheet is peripherally-coated on four sides.

3. The adhesive-coated sheet of claim 1, wherein said sheet comprises a paper perimeter portion and a transparent film central portion.

4. The adhesive-coated sheet of claim 1, wherein said sheet is constructed of a transparent film.

5. The adhesive-coated sheet of claim 4, wherein a peripheral portion of the face of said sheet opposite the adhesive-coated face is textured such that manual writing is facilitated.

6. The adhesive-coated sheet of claim 1, wherein said central portion is a transparent film.

7. The adhesive-coated sheet of claim 1, wherein said adhesive-coated sheet is mounted on a release liner.

8. The adhesive-coated sheet of claim 7, wherein said adhesive-coated sheet mounted on a release liner is printable with an ink jet printer.

9. The adhesive-coated sheet of claim 7, wherein said adhesive-coated sheet on a release liner is printable with a laser printer.

10. The adhesive-coated sheet of claim 1, wherein said adhesive-coated sheet is in a pad of said sheets.

11. The adhesive-coated sheet of claim 1, wherein said central portion is contoured.

12. The adhesive-coated sheet of claim 1, wherein said central portion is expandable.

13. The adhesive-coated sheet of claim 11, wherein said central portion is pleated, folded, or gathered.

14. The adhesive-coated sheet of claim 11, wherein said central portion is stretchable.

15. The adhesive-coated sheet of claim 1, wherein said sheet is waterproof.

16. The adhesive-coated sheet of claim 1, wherein said sheet comprises a machine-printable portion.

17. The adhesive-coated sheet of claim 16, wherein said machine-printable portion is along one edge and not along two adjacent edges.

18. The adhesive coated sheet of claim 16, wherein said machine-printable portion is along two non-adjacent edges, and not along the two adjacent edges.

19. The adhesive coated sheet of claim 1, wherein said sheet comprises a paper portion along one edge and transparent film along the other three edges and across said central portion.

20. The adhesive coated sheet of claim of claim 1, wherein said sheet comprises a paper portion along two non-adjacent edges and not along the other two edges.

21. The adhesive coated sheet of claim 1, wherein said sheet comprises a plurality of transparent window portions separated by repositionable adhesive coated portions on one face.

22. A kit comprising
a plurality of flexible sheets peripherally coated on a face of each sheet with a pressure sensitive, repositionable adhesive, wherein a central portion of each sheet is not coated with said adhesive; and
instructions for use of said sheets.

23. The kit of claim 22, wherein said sheets are adhesive-coated sheets of claim 1.

24. A method for retaining an object on a surface, comprising
covering said object with a flexible, windowed sheet comprising a pressure sensitive adhesive coating on at least three sides of one face, wherein a central portion of said sheet is not coated with said adhesive; and
sealing said pressure sensitive adhesive coating on said surface.

25. The method of claim 24, wherein said sheet is an adhesive-coated sheet of claim 1.
